(19) United States
(12) Patent Application Publication
(10) Pub. No.: US 2005/0181753 A1
(43) Pub. Date: Aug. 18, 2005

(54) Logic low noise amplifier and amplification control method thereof

(76) Inventor: Yong Kyu Kim, Gwangju-si (KR)

Correspondence Address: BIRCH STEWART KOLASCH & BIRCH, PO BOX 747, FALLS CHURCH, VA, 22040-0747, US

(21) Appl. No.: 10/511,842

(22) PCT Filed: Feb. 20, 2004
(86) PCT No.: PCT/KR04/00359

(30) Foreign Application Priority Data
Feb. 22, 2003 (KR) 10-2003-0011175

(51) Int. Cl. H04B 1/16

(52) U.S. Cl. 455/194.2

(57) ABSTRACT

The present invention relates to a logic low noise amplifier and an amplification control method thereof. The low noise amplifier including: an RF amplification control circuit unit for controlling an amplification of an RF signal depending on an electric field intensity of the RF signal; a low noise amplification circuit unit for amplifying the RF signal under control of the RF amplification control circuit unit; and a through circuit unit for allowing the RF signal to pass therethrough under control of the RF amplification control circuit unit.

### TECHNICAL FIELD

The present invention relates to a low noise amplifier, and more particularly, to a logic low noise amplifier and an amplification control method thereof in which a gain of a RF amplifier can be controlled for all strong and weak electric-field RF signals inputted through an antenna, by using a hysteresis characteristic of a Schmitt trigger circuit, which compares a Direct Current (DC) input level outputted from an Automatic Gain Control (AGC) detector with a reference level to output an inverse signal.

### BACKGROUND ART

Generally, a radio wave received at an RF receiving terminal has a very low power level due to an influence of reduction and noise. Therefore, the RF receiving terminal requires a procedure of amplifying the received signal.

However, when the received signal is amplified, a noise signal as well as a desired signal is amplified due to an external noise included in the received signal. Accordingly, the RF receiving terminal requires a function of minimizing the noise while amplifying the received signal.

In order to satisfy the function of minimizing the noise while amplifying the received signal at the RF receiving terminal, a Low Noise Amplifier (LNA) has been developed. The low noise amplifier is designed to have low noise figure by adjusting an operation point and a matching point.

The most important factor for determining the noise figure of any entire system is a noise figure value of an initial block of a system. This is because the noise figure of the entire system is most greatly improved when the noise figure of the initial block is small and a gain is large. Accordingly, as a intial unit of the receiving terminal, a role of the low noise amplifier is important.

An RF receiver using low noise amplifier of the related art includes a transistor and a bias circuit as shown in FIG. 1.

In detail, the RF receiver includes a low noise amplifier 1 for amplifying only an RF signal among signals induced through an antenna ANT, an input tuner 2 for tuning and outputting a desired band signal among the RF signal outputted through the low noise amplifier 1, an RF amplifier 3 for amplifying the RF signal outputted through the input tuner depending on a magnitude of a DC voltage inputted from an external, an RF tuner 4 for secondarily tuning and outputting the RF signal outputted through the RF amplifier 3, a mixer 5 for mixing an oscillating frequency inputted from the external with the RF signal of the RF tuner 4 to output an IF signal therefrom, a local oscillator 6 for generating the oscillating frequency to transmit the generated frequency to the mixer 5, an IF amplifier 7 for amplifying and outputting the IF signal outputted from the mixer 5, and an AGC detector 8 for converting a strength of the IF signal outputted from the IF amplifier 7 into a DC voltage and outputting the converted DC voltage therefrom to control a gain of the RF amplifier 3.

However, the related art RF receiver controls the gain of the RF amplifier depending on the electric field intensity of an received signal to accomplish smooth receiving, but has a drawback of a narrow operation band. That is, the related art low noise amplifier embodies a desired performance for only any one of a weak electric-field signal and a strong electric-field signal, and does not satisfy a performance required by the RF receiver, for all of the weak electric-field signal and the strong electric-field signal.

In other words, the related art low noise amplifier has a drawback in that it is difficult to realize the desired performance for both the weak electric-field signal and the strong electric-field signal since it has a limited range of electric field intensity for receiving

In particular, the related art low noise amplifier has a drawback in that receiving is more difficult when a multiple signal is inputted due to an intermodulation characteristic of the low noise amplifier.

In order to solve the above drawback, the low noise amplifier is greatly required to control an amplification gain of the RF receiver, and have a constant receiving performance for the RF signal having the wider range of electric field intensity induced to the antenna.

### DISCLOSURE OF THE INVENTION

Accordingly, the present invention is directed to a logic low noise amplifier and an amplification control method thereof that substantially obviate one or more of the problems due to limitations and disadvantages of the related art.

An object of the present invention is to provide a logic low noise amplifier having a uniform performance for an RF signal having a wider range of electric field intensity.

Another object of the present invention is to provide a logic low noise amplifier, which stably operates for a weak electric-field signal and a strong electric-field signal, by using a hysteresis characteristic of a Schmitt trigger circuit and an AGC voltage inputted to the Schmitt trigger circuit to allow the weak electric-field signal amplified through a low noise amplification circuit unit to pass therethrough and to allow the low noise amplification circuit unit to be turned off and the strong electric-field signal to be bypassed to a through circuit unit to thereby have only a passage characteristic.

A further another object of the present invention is to provide an amplification control method of a low noise amplifier using a hysteresis characteristic of a Schmitt trigger circuit.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

According to the present invention, it operates stably for the RF signal having a wider range of electric-field intensity in comparison with a related art RF receiver. Further, the present invention has a good selectivity as much as a gain characteristic of the low noise amplification circuit unit for weak electric-field signal, and a better selectivity due to a better AGC reduction characteristic for the strong electric-field signal.

Further, the low noise amplifier of the present invention can allow the RF receiver to control the amplification and have a stable receiving performance when it is used for the RF receiver such as a tuner.

### BRIEF DESCRIPTION OF THE DRAWINGS

Other features and advantages of the invention will be apparent from the following detailed description and the accompanying drawings, in which:

FIG. 1 is a block diagram illustrating a construction of an RF receiver including a cutomary low noise amplifier;

FIG. 2 is a block diagram illustrating a construction of an RF receiver including a low noise amplifier according to a preferred embodiment of the present invention;

FIG. 3 is a circuit diagram illustrating a construction of a low noise amplifier according to a preferred embodiment of the present invention;

FIG. 4 is a graph illustrating a hysteresis characteristic curve of a low noise amplifier according to a preferred embodiment of the present invention;

FIG. 5 is a graph illustrating a hysteresis curve of a low noise amplifier according to a preferred embodiment of the present invention, and an operation characteristic of an RF receiver including the low noise amplifier according to a preferred embodiment of the present invention;

FIG. 6 is a graph illustrating a characteristic and a passage characteristic gain of a low noise amplifier according to a preferred embodiment of the present invention; and

FIG. 7 is a flow chart illustrating an amplification control method of an RF receiver according to a preferred embodiment of the present invention.

### BEST MODE FOR CARRYING OUT THE INVENTION

Hereinafter, preferred embodiments of the present invention will be described in detail with reference to accompanying drawings.

FIG. 2 is a block diagram illustrating a construction of an RF receiver including a low noise amplifier according to a preferred embodiment of the present invention.

The RF receiver having the low noise amplifier according to a preferred embodiment of the present invention includes: a low noise amplifier 100 for amplifying only an RF signal among signals induced through an antenna ANT; an input tuner 101 for tuning and outputting a desired band signal among the RF signal outputted through the low noise amplifier 100; an RF amplifier 102, which is controlled by a DC voltage outputted from the AGC detector 107 and amplify the RF signal outputted through the input tuner 101; an RF tuner 103 for secondarily tuning and outputting the RF signal outputted through the RF amplifier 102; a mixer 104 for mixing an oscillating frequency inputted from an external with the RF signal of the RF tuner 103 to output an IF signal therefrom; a local oscillator 105 for generating the oscillating frequency to transmit the generated frequency to the mixer 104; an IF amplifier 106 for amplifying and outputting the IF signal outputted from the mixer 104; an AGC detector 107 for converting a strength of the IF signal outputted from the IF amplifier 106 into a DC voltage and outputting the converted DC voltage therefrom to control a gain of the RF amplifier 102, and controlling an output of a Schmitt trigger circuit unit 110.

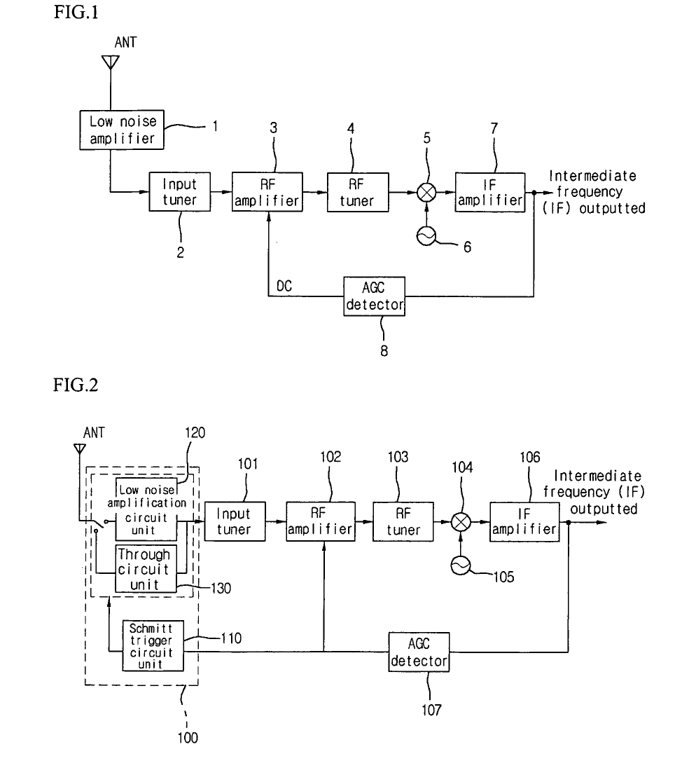

Referring to FIGS. 1 and 2, an RF receiver including a related art low noise amplifier is compared with the RF receiver including the low noise amplifier of the present invention as follows.

As shown in FIG. 1, in the related art RF receiver, a DC voltage value outputted from an AGC detector 8 is inputted to an RF amplifier 3 to control a gain of the RF amplifier 3.

However, as shown in FIG. 2, in the RF receiver of the present invention, a DC voltage value outputted from the AGC detector 107 is inputted to both the RF amplifier 102 and the Schmitt trigger circuit unit 110.

The Schmitt trigger circuit unit 110 outputs a switching control voltage for controlling whether the RF signal received through an antenna ANT is amplified using a low noise amplification circuit unit 120, or the RF signal is bypassed through a through circuit unit 130 to be directly inputted to the input tuner 101. That is, the Schmitt trigger circuit unit 110 controls whether or not the RF signal is amplified.

In detail, a logic Integrated Circuit (IC) 111 included in the Schmitt trigger circuit unit 110 outputs the switching control voltage for controlling a first transistor Q1 and a second transistor Q2 depending on the DC voltage value outputted from the AGC detector 107.

The switching of the first transistor which is turned on/off by the switching control voltage controls the gain of the RF amplifier by determining whether the RF signal received through the antenna ANT to be amplified at the low noise amplification circuit unit 120 or to be bypassed through the through circuit unit 130.

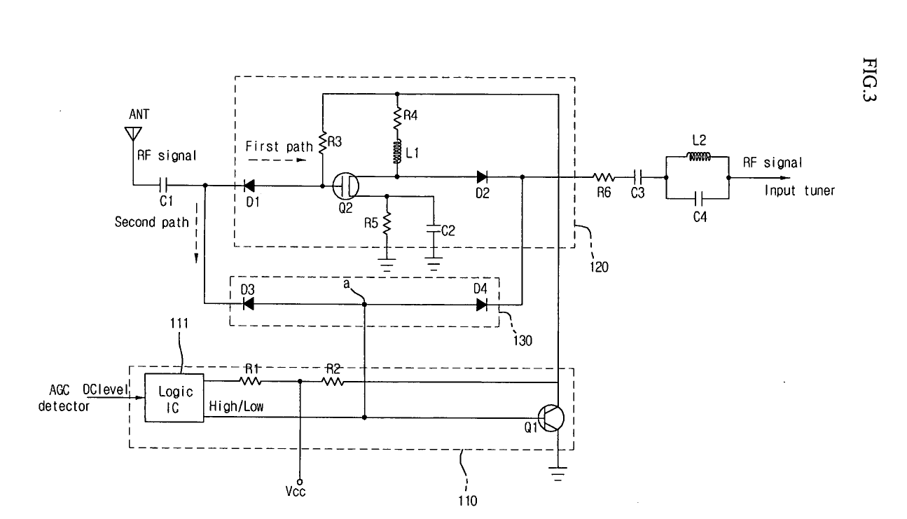

FIG. 3 is a circuit diagram illustrating a construction of the low noise amplifier 100 according to a preferred embodiment of the present invention.

The low noise amplifier 100 of the present invention includes the Schmitt trigger circuit unit 110, the low noise amplification unit 120, and the through circuit unit 130.

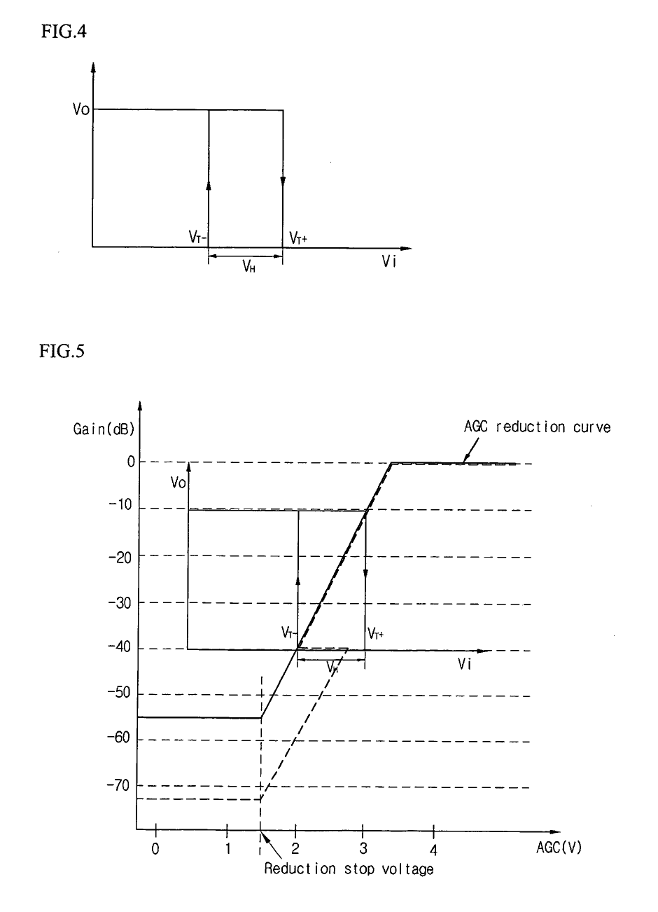

Hereinafter, the construction of the inventive low noise amplifier is in detail described with reference to FIGS. 3 and 4.

First, the Schmitt trigger circuit unit 110 includes the logic IC 111 and the first transistor Q1.

The Schmitt trigger circuit unit 110 outputs the switching control voltage depending on the DC voltage value outputted from the AGC detector 107.

The switching control voltage causes the low noise amplification circuit unit 120 to be in operation, thereby amplifying the received RF signal in case that the RF signal received through the antenna ANT is the weak electric-field signal, and the switching control voltage causes the through circuit unit 130 to be in operation thereby bypassing the received RF signal to the input tuner in case that the RF signal is the strong electric-field signal.

The logic IC 111 having an input terminal connected to an output terminal of the AGC detector outputs a high/low-leveled switching control voltage depending on a comparative result of the reference level with a DC input level inputted through the input terminal.

Herein, in the reference level of the logic IC 111, a reference level V_{T-} at the time of outputting the high-leveled switching control voltage is different from a reference level V_{T+} at the time of outputting the low-leveled switching control voltage, and the reference level V_{T+} at the time of outputting the low-leveled switching control voltage is higher than the reference level V_{T-} at the time of outputting the high-leveled switching control voltage. Further, the switching control voltage outputted from the logic IC 111 should have the hysteresis characteristic as shown in FIG. 4.

Describing in detail with reference to FIG. 4, when the DC input value Vᵢ outputted from the AGC detector and inputted to the logic IC 111 is more than the reference level V_{T+}, the logic IC 111 outputs the low-leveled switching control voltage therefrom. Further, when the DC voltage value Vᵢ is less than the reference level V_{T-}, the logic IC 111 outputs the high-leveled switching control voltage therefrom.

At this time, the reference level V_{T+} at the time of outputting the low-leveled switching control voltage should be higher than the reference level V_{T-} at the time of outputting the high-leveled switching control voltage. That is, the reference level V_{T+} should be higher than the reference level V_{T-}. In case that this condition is satisfied, the output of the logic IC 111 represents the hysteresis characteristic as in FIG. 4.

In other words, when the DC voltage value Vᵢ inputted to the logic IC 111 drops below the reference level V_{T-}, an output voltage Vo of the logic IC 111 is in a high state. On the contrary, when the DC voltage value Vᵢ inputted to the logic IC 111 gradually rises to be more than the reference level V_{T+}, the output voltage Vo of the logic IC 111 is in a low state.

The logic IC 111 has an output terminal connected to a base and an emitter of the first transistor Q1. Further, the first transistor Q1 has a collector connected to the ground.

In the meanwhile, the first transistor Q1 is switched depending on the switching control voltage of the logic IC 111.

Describing in detail, if the DC voltage value inputted to the logic IC 111 rises, the logic IC 111 outputs the low-leveled switching control voltage at the output terminal thereof, and the first transistor Q1 is turned off.

On the contrary, if the DC voltage value inputted to the logic IC 111 drops, the logic IC 111 outputs the low-leveled switching control voltage at the output terminal thereof, and the first transistor Q1 is turned on.

Next, the low noise amplification circuit unit 120 is described.

The low noise amplification circuit unit 120 is switched depending on the switching control voltage outputted from the Schmitt trigger circuit unit 110 to amplify the RF signal inputted through the antenna and output the amplified RF signal through a first path series-connected between the antenna and the input tuner when the weak electric-field signal is inputted.

The low noise amplification circuit unit includes the second transistor Q2, the first diode D1 and the second diode D2.

The second transistor Q2 being a Field Effect transistor (FET) has a gate and a drain respectively connected to the first path and a source grounded to the ground. Further, the second transistor Q2 has a gate and a drain respectively connected in parallel with an emitter of the first transistor Q1, and operates depending on the switching of the first transistor Q1 to amplify and output the RF signal inputted through the antenna ANT.

The first diode D1 is connected between the antenna ANT and the gate of the second transistor Q2. In detail, the first diode D1 has a cathode connected to the antenna ANT, and an anode connected to the gate of the second transistor Q2.

In the meantime, the second diode D2 is connected between the drain of the second transistor Q2 and the input tuner 101. In detail, the second diode D2 has a cathode connected to the input tuner, and an anode connected to the drain of the second transistor Q2.

Next, a construction of the through circuit unit 130 is described.

The through circuit unit 130 is comprised of a third diode D3 and a fourth diode D4.

The third diode D3 is connected between a second path and a connection node (a) of the logic IC 111. In detail, the third diode D3 has a cathode connected to the second path, and an anode connected to the connection node (a).

Further, the fourth diode D4 is connected between the connection node (a) of the logic IC 111 and the input tuner. In detail, the fourth diode D4 has a cathode connected to the input tuner, and an anode connected to the connection node (a) of the logic IC 111.

The third diode D3 and the fourth diode D4 are switched by the first transistor Q1 that is turned on/off depending on the switching control voltage of the logic IC 111.

Non-described reference numerals C1 to C4 represent capacitors, L1 to L2 represent inductors, and R1 to R6 represent resistors.

Hereinafter, an operation of the inventive low noise amplifier is in detail described.

First, if the DC voltage value outputted from the AGC detector and inputted to the logic IC rises, the low-leveled switching control voltage is outputted from the logic IC 111 of the Schmitt trigger circuit unit 110. The low-leveled switching control voltage causes the first transistor Q1 of the Schmitt trigger circuit unit 110 to be turned off.

At the same time, a low level voltage is applied to the anodes of the third diode D3 and the fourth diode D4. This causes the third diode D3 and the fourth diode D4 to be turned off, and causes the second path to be opened.

In the meantime, if the first transistor Q1 is turned off, a high level DC voltage is applied to the gate and the drain of the second transistor Q2. Accordingly, since the second transistor Q2 is turned on and at the same time, the high level voltage is respectively applied to the anodes of the first diode D1 and the second diode D2, the first diode D1 and the second diode D2 are turned on thereby shorting the first path.

Accordingly, after the signal inputted through the antenna ANT is inputted through the first path and amplified at the second transistor Q2 through the first diode D1, the amplified signal is inputted to the input tuner 101 via the second diode D2.

To the contrary, if the DC voltage value outputted from the AGC detector and inputted to the logic IC drops, the high-leveled switching control voltage is outputted from the logic IC 111. The high-leveled switching control voltage causes the first transistor Q1 of the Schmitt trigger circuit unit 110 to be turned on.

At the same time, a high level voltage is applied to the anodes of the third diode D3 and the fourth diode D4. This causes the third diode D3 and the fourth diode D4 to be turned on, and causes the second path to be shorted.

In the meantime, if the first transistor Q1 is turned on, a low level DC voltage is applied to the gate and the drain of the second transistor Q2. Accordingly, since the second transistor Q2 is turned off and at the same time, the low level voltage is respectively applied to the anodes of the first diode D1 and the second diode D2, the first diode D1 and the second diode D2 are turned off thereby opening the first path.

Accordingly, the signal inputted through the antenna ANT is inputted to the input tuner 101 through the third diode D3 and the fourth diode D4 via the second path.

At this time, the switching control voltage of the logic IC 111 traces, as shown in FIG. 4, the hysteresis characteristic curve where the output voltage Vo is in a high level when the inputted DC voltage drops below the V_{T-}, and on the contrary the output voltage Vo is in a low level when the inputted DC voltage gradually rises to be more than the V_{T+}.

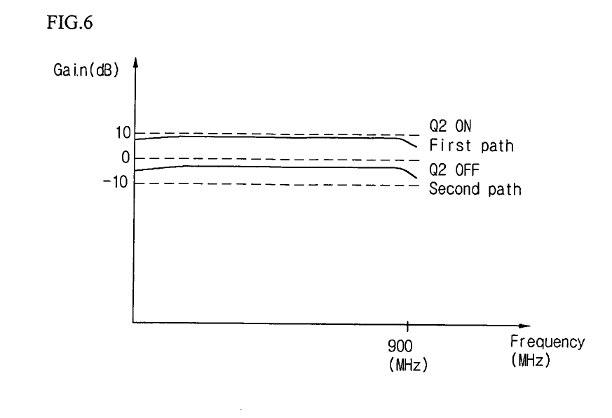

Hereinafter, a procedure of controlling an operation characteristic of the RF receiver including the inventive low noise amplifier depending on an on/off state of the low noise amplifier is described with reference to FIGS. 5 and 6.

FIG. 5 is a graph illustrating a hysteresis curve of the low noise amplifier according to a preferred embodiment of the present invention, and the operation characteristic of the RF receiver including the low noise amplifier according to a preferred embodiment of the present invention.

FIG. 6 is a graph illustrating a characteristic and a passage characteristic gain of the low noise amplifier according to a preferred embodiment of the present invention.

In FIG. 5, a solid line represents an AGC reduction curve of a related art RF receiver, and a dotted line represents an AGC reduction curve of the RF receiver including the low noise amplifier according to the present invention.

If the Vᵢ rises to reach the V_{T+} in the hysteresis curve of FIG. 5, the output voltage Vo drops to a low level. Further, since the first transistor Q1 is turned off thereby causing current not to flow, a DC bias is supplied to the second transistor Q2 to amplify the input signal. At this time, the first and second diodes D1 and D2 are turned on, and the third and fourth diodes D3 and D4 are turned off.

To the contrary, if the Vᵢ drops to reach the V_{T-}, the output voltage Vo is in the high level such that the first transistor Q1 is turned on and the current flow to the emitter of the first transistor Q1. Accordingly, the DC bias is not supplied to the second transistor Q2 thereby turning off the second transistor Q2.

The AGC reduction curve of the related art RF receiver has about 0 to 50 dB of reduction as shown in the solid line of FIG. 5. To the contrary, the inventive RF receiver has a double reduction caused by the hysteresis curve characteristic of the Schmitt trigger circuit as shown in the dotted line.

In detail, if the DC voltage value Vᵢ outputted from the AGC detector 107 drops below the reference level V_{T-}, the low noise amplification circuit unit 120 is turned off. In case that the low noise amplification circuit unit 120 is turned off, the signal passing through the low noise amplifier has only about 3 dB reduction characteristic as shown in FIG. 6. Accordingly, signal strength detected at the AGC detector 107 is weakened, and the DC voltage value outputted from the AGC detector 107 rises.

In other words, like when the strong electric-field signal is inputted, in case that the DC voltage value outputted from the AGC detector drops to less than the reference level V_{T-}, the DC voltage value rises again so that the inventive low noise amplifier can stably operate even for the RF signal having a stronger electric field.

In the same manner, if the DC voltage value Vᵢ outputted from the AGC detector 107 rises above the reference level V_{T+}, the low noise amplification unit 120 is turned on. In case that the low noise amplification unit 120 is turned on, the signal passing through the low noise amplifier has an amplification characteristic as shown in FIG. 6. Accordingly, the signal strength detected at the AGC detector 107 is strengthened, and the DC voltage value outputted from the AGC detector 107 drops.

In other words, like when the weak electric-field signal is inputted, in case that the DC voltage value outputted from the AGC detector rises to more than the reference level V_{T+}, the DC voltage value drops again so that the low noise amplifier of the present invention can stably operate even for the RF signal having a more weak electric field.

Accordingly, a reduction width is increased as much as a duplicated region, and FIG. 5 illustrates the case when a reduction occurs more than about 70 dB.

Herein, the reference levels V_{T+} and V_{T-} can be varied to control the reduction width.

As shown in FIG. 6, when the RF signal inputted through the antenna is the strong electric-field signal, the second transistor Q2 is turned off, and the inputted RF signal is inputted to the input tuner through the second path. Accordingly, the strong electric field RF signal has only a constant reduction characteristic (about 3 dB) by a Resistance Series (RS) value of the first and second diodes D1 and D2.

However, when the RF signal inputted through the antenna is the weak electric-field signal, the second transistor Q2 is turned on, and the inputted RF signal is inputted to the low noise amplification circuit unit 120 through the first path. Accordingly, the weak electric-field RF signal is amplified by a gain value of the low noise amplification circuit unit 120.

Arranging the above, the low noise amplifier of the present invention has a good selectivity as much as the gain characteristic of the low noise amplifier when the weak electric-field signal is inputted, and has the improved AGC reduction characteristic and a better selectivity by the passage reduction characteristic when the strong electric-field signal is inputted.

Accordingly, the low noise amplifier of the present invention has a difference in a gain characteristic of the RF amplifier of the RF receiver depending on a variation of a hysteresis region due to the hysteresis curve characteristic being an output characteristic of the logic IC 111 to allow the gain to be controlled even at a strong electric field or a weak electric field by the gain difference of the on/off state of the logic low noise amplifier.

Further, the operation region of the RF signal for allowing the RF receiver to be in a normal operation is widen. In other words, a range of an electric field intensity of the RF signal for a normal operation is widen.

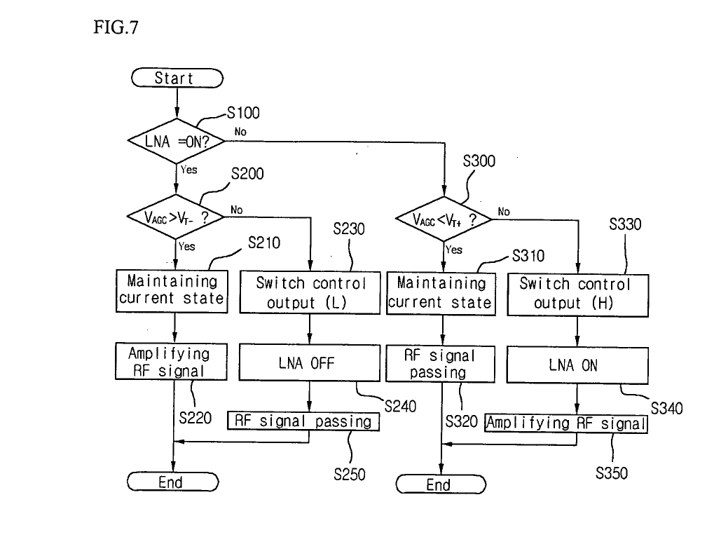

Hereinafter, the amplification control method of the RF receiver is described with reference to FIG. 7.

In the amplification control method of the RF receiver according to the present invention, the RF receiver includes the low noise amplifier having the low noise amplification circuit unit, the input tuner, the amplifier and the detector.

The inventive amplification control method of the low noise amplifier includes a first step of checking an on/off state of the low noise amplification circuit unit (S100); a second step of comparing the AGC voltage V_{AGC} and the reference level V_{T-} for turning off the low noise amplification circuit unit (S200) in case that the low noise amplification circuit unit is turned on as a check result of the first step (S100), and comparing the AGC voltage V_{AGC} and the reference level V_{T+} for turning on the low noise amplification circuit unit (S300) in case that the low noise amplification circuit unit is turned off as the check result of the first step (S100); and a third step of maintaining a current on/off state of the low noise amplification circuit unit (S210) (S310) or inverting the current on/off state of the low noise amplification circuit unit (S240) (340) as a check result of the second step (S200) (S300).

Describing in detail, first, the on/off state of the low noise amplifier LNA is checked (S100). That is, it is checked whether the low noise amplifier is in the on state for allowing the received RF signal to be amplified, or is in the off state for allowing the received RF signal to pass therethrough without amplification.

In case that the low noise amplifier LNA is in the on state as the check result of the step (S100), the AGC voltage outputted from the AGC detector is compared with the reference level V_{T-} for turning off the low noise amplification circuit unit (S200).

In case that the AGC voltage is more than the reference level V_{T-} for turning off the low noise amplifier as the check result of the step (S200), the current state, that is, the on state of the low noise amplifier is maintained (S210), and the received RF signal is amplified by the low noise amplifier (S220).

Further, in case that the AGC voltage is less than the reference level V_{T-} for turning off the low noise amplifier as the check result of the step (S200), a switch control output L for turning off the low noise amplifier is outputted (S230), the low noise amplifier is turned off by the switch control output L (S240), and then the received RF signal passes through without amplification (S250).

In the meanwhile, in case that the low noise amplifier LNA is in the off state as the check result of the on/off state of the low noise amplifier LNA (S100), the AGC voltage outputted from the AGC detector is compared with the reference level V_{T+} for turning on the low noise amplification circuit unit (S300).

In case that the AGC voltage is less than the reference level V_{T+} for turning on the low noise amplifier as the check result of the step (S300), the current state, that is, the off state of the low noise amplifier is maintained (S310), and the received RF signal is not amplified and passes through (S320).

Further, in case that the AGC voltage is more than the reference level V_{T+} for turning on the low noise amplifier as the check result of the step (S300), a switch control output H for turning on the low noise amplifier is outputted (S330), the low noise amplifier is turned on by the switch control output H (S340), and then the received RF signal is amplified (S350).

The above-described amplification control method of the RF receiver uses the hysteresis characteristic variation of the Schmitt trigger circuit, and the DC voltage outputted from the AGC detector so as to operate the low noise amplifier.

In other words, the low noise amplifier is turned on to amplify the received weak electric-field signal, and the low noise amplifier is turned off to allow the strong electric-field signal to pass therethrough without amplification.

This causes the AGC reduction to be achieved as much as the gain difference at the time of turning-on/off the low noise amplifier such that the low noise amplifier of the present invention be stably operated and has a high selectivity at the range of the electric field intensity.

### INDUSTRIAL APPLICABILITY

As described above, in the logic low noise amplifier and the amplification control method of the present invention, a stable operation can be achieved for the RF signal having a wider range of electric field intensity. Specifically, when the strong electric field signal and the weak electric-field signal are inputted, the gain of the RF receiver can be controlled such that the wider range of the RF signal has optimal reception selectivity.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A low noise amplifier used for an RF (Radio Frequency) receiver having an antenna, an input tuner, an amplifier and a detector, the low noise amplifier comprising:
an RF amplification control circuit unit for controlling an amplification of an RF signal depending on an electric field intensity of the RF signal;
a low noise amplification circuit unit for amplifying the RF signal under control of the RF amplification control circuit unit; and
a through circuit unit for allowing the RF signal to pass therethrough under control of the RF amplification control circuit unit.

2. The low noise amplifier of claim 1, wherein the RF amplification control circuit unit compares an input level outputted from the detector with a reference level to allow the low noise amplification circuit unit or the through circuit unit selectively to be in operation.

3. The low noise amplifier of claim 1, wherein the low noise amplification circuit unit is switched under control of the RF amplification control circuit unit, and amplifies and outputs the RF signal inputted through the antenna when a weak electric-field signal is inputted.

4. The low noise amplifier of claim 1, wherein the through circuit unit is switched under control of the RF amplification control circuit unit, and allows the RF signal inputted through the antenna to pass therethrough when a strong electric-field signal is inputted.

5. The low noise amplifier of claim 1, wherein the RF amplification control circuit unit comprises a logic IC (Integrated Circuit) for comparing the input level outputted from an output terminal of the detector with the reference level to output a high/low level signal.

6. The low noise amplifier of claim 5, wherein the RF amplification control circuit unit further comprises a switching unit connected to the logic IC, for switching depending on an output signal of the logic IC.

7. The low noise amplifier of claim 6, wherein the switching unit is a transistor having a base and an emitter connected to an output terminal of the logic IC, and a collector connected to the ground.

8. The low noise amplifier of claim 1, wherein the RF amplification control circuit unit comprises the logic IC for comparing the input level outputted from the detector with the reference level to output the high/low level signal, and allows the reference level at the time of outputting the high level signal to be different from the reference level at the time of the low level signal and allows the reference level at the time of outputting the low level signal to be more than the reference level at the time of outputting the high level signal such that the reference level of the logic IC have a hysteresis characteristic.

9. The low noise amplifier of claim 1, wherein the low noise amplification circuit unit comprises:
an amplifying unit for amplifying and outputting the RF signal inputted through the antenna;
a first diode connected between the antenna and the amplifying unit; and
a second diode connected between the amplifying unit and the input tuner.

10. The low noise amplifier of claim 1, wherein the through circuit unit comprises:
a first diode connected in parallel with the low noise amplification circuit unit and connected with the antenna; and
a second diode connected between the first diode and the input tuner.

11. A logic low noise amplifier comprises:
an RF amplification control circuit unit for controlling an amplification of an RF (Radio Frequency) signal depending on electric field intensity of the RF signal;
a low noise amplification circuit unit for amplifying the RF signal under control of the RF amplification control circuit unit; and
a through circuit unit for allowing the RF signal to pass therethrough under the control of the RF amplification control circuit unit.

12. The logic low noise amplifier of claim 11, wherein the RF amplification control circuit unit further comprises a logic IC, and a switching unit connected with the logic IC.

13. The logic low noise amplifier of claim 11, wherein the low noise amplification circuit unit further comprises an amplifying unit, a first diode connected between the antenna and the amplifying unit, and a second diode connected between the amplifying unit and the input tuner.

14. The logic low noise amplifier of claim 11, wherein the through circuit unit further comprises a first diode connected in parallel with the low noise amplification circuit unit and connected with the antenna, and a second diode connected between the first diode and the input tuner.

15. The logic low noise amplifier of claim 11, wherein the RF amplification control circuit unit comprises the logic IC and the switching unit connected with the logic IC, and
wherein the low noise amplification circuit unit further comprises the amplifying unit and the first diode connected between the antenna and the amplifying unit, and the second diode connected between the amplifying unit and the input tuner, and
wherein the through circuit unit is connected in parallel with the low noise amplification unit and further comprises a third diode connected with the antenna and a fourth diode connected between the third diode and the input tuner.

16. A control method of an RF receiver having a low noise amplifier with a low noise amplification circuit unit, an input tuner, an amplifier and a detector, the control method comprising:
a first step of checking an on/off state of the low noise amplification circuit unit;
a second step of comparing a control voltage with a reference level for turning off the low noise amplification circuit unit in case that the low noise amplification circuit unit is in the on state as a check result of the first step, and comparing the control voltage with a reference level for turning on the low noise amplification circuit unit in case that the low noise amplification circuit unit is in the off state; and
a third step of selecting whether amplification or passage of the RF signal depending on the check result of the second step.

17. The control method of claim 16, further comprising a step of maintaining a current state and amplifying the RF signal in case that the low noise amplification circuit unit is in the on state as the check result of the first step and the control voltage is more than the reference level for turning off the low noise amplification circuit unit as a check result of the second step.

18. The control method of claim 16, further comprising a step of outputting a switch control for turning off the low noise amplification circuit unit, and allowing the RF signal to pass through in case that the low noise amplification circuit unit is in the on state as the check result of the first step and the control voltage is less than the reference level for turning off the low noise amplification circuit unit as the check result of the second step.

19. The control method of claim 16, further comprising a step of maintaining the current state, and amplifying the RF signal in case that the low noise amplification circuit unit is in the off state as the check result of the first step and the control voltage is less than the reference level for turning on the low noise amplification circuit unit as the check result of the second step.

20. The control method of claim 16, further comprising a step of outputting a switch control for turning on the low noise amplification circuit unit, and amplifying the RF signal in case that the low noise amplification circuit unit is in the off state as the check result of the first step and the control voltage is more than the reference level for turning on the low noise amplification circuit unit as the check result of the second step.
